(19) United States
(12) Patent Application Publication
(10) Pub. No.: US 2020/0204090 A1
(43) Pub. Date: Jun. 25, 2020

(54) METHOD, SYSTEM, AND APPARATUS FOR PROVIDING MAGNETIC-ASSISTED MOVEMENT IN OPPOSITION TO GRAVITY

(71) Applicant: Paul DABNEY, Georgetown, TX (US)

(72) Inventor: Paul DABNEY, Georgetown, TX (US)

(21) Appl. No.: 16/718,551

(22) Filed: Dec. 18, 2019

Related U.S. Application Data
(60) Provisional application No. 62/781,764, filed on Dec. 19, 2018.

(51) Int. Cl. H02N 99/00; H01F 7/02; H01F 7/06

(52) U.S. Cl. CPC H02N 99/00; H01F 7/06; H01F 7/02

(57) ABSTRACT

An apparatus for mitigating the forces of friction. The apparatus includes a hollow hub having a void therein and rotationally mounted on a support, and a plurality of hollow spokes coupled to and extending from the hub, each spoke of the plurality of spokes having a void therein, the voids being in communication with each other. A magnetically sensitive substance is disposed within the void of the spokes and the void of the hub. A circular rim surrounds the spokes such that the distal end of each spoke is disposed proximate the rim without contacting the rim. A magnet is disposed on the rim in sufficient proximity and strength to exert a force on the magnetically sensitive substance within a spoke when the distal end of the spoke is proximate the magnet. As the hub rotates, the magnetically sensitive substance moves within the void of the spoke due to gravity.

### CROSS-REFERENCE TO RELATED APPLICATIONS

This application claims priority to U.S. Provisional Application 62/781,764, filed Dec. 19, 2018, and entitled METHOD, SYSTEM, AND APPARATUS FOR PROVIDING MAGNETIC-ASSISTED MOVEMENT, the entire contents of which are hereby incorporated by reference.

### BACKGROUND

Traditional power sources, such as coal, nuclear or hydro-electric power supplies are not considered sustainable or have negative environmental impacts. Other alternative power sources, including solar and wind energy, have very high barriers to entry, are inefficient and suffer from other negative environmental impacts. Thus, more sustainable, higher yielding power sources are needed.

### SUMMARY

By utilizing the many characteristics of magnets and magnetic fields, a precise force vector can be ascertained that can overcome the force vectors attributed to gravity. In exemplary embodiments described herein, the magnetic force vectors may be applied in direct opposition to the force vectors of gravity or in a tangential manner. An example of a tangential manner could be a loop or circle.

Thus, an exemplary embodiment describes a method of creating a balance and/or an alternating imbalance between gravitational fields and magnetic fields. This balanced and/or alternating imbalanced system can create movement or motion along vectors that when balanced and/or alternatingly imbalanced allows for continuous motion which overcomes the forces of friction along these same vectors.

### BRIEF DESCRIPTION OF THE FIGURES

Advantages of embodiments of the present invention will be apparent from the following detailed description of the exemplary embodiments thereof, which description should be considered in conjunction with the accompanying drawings in which like numerals indicate like elements, in which:

FIG. 1 shows an exemplary embodiment of a device for overcoming or significantly mitigating the forces of friction.

FIG. 2 is a cutaway view of a spoke and hub of an exemplary embodiment of a device for overcoming or significantly mitigating the forces of friction.

FIG. 3 shows an example of Newton's third law.

FIG. 4 shows the maximum energy product on a plot of a B-H curve.

FIG. 5 shows the residual flux density on a plot of a B-H curve.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

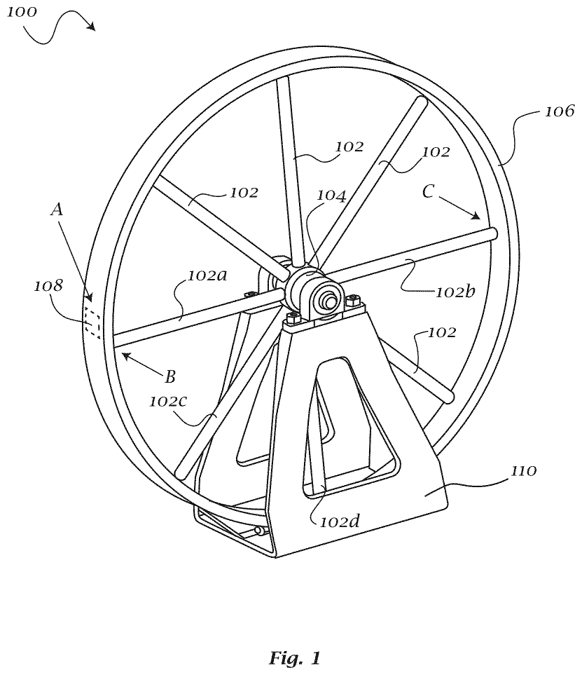

Exemplary embodiments described herein relate to a system and/or device utilizing vector forces and magnets as a power source, as shown in exemplary FIG. 1. The force of gravity is the force with which objects attract each other. While gravity is the weakest of the fundamental forces, in the case of massively large objects such as the earth, moon, sun, and so forth, the force of gravity is sufficiently large to attract other objects towards the massively large object. By definition, this is the weight of the object. All objects upon earth experience a force of gravity that is directed “downward” towards the center of the earth. The force of gravity on earth is always equal to the weight of the object as found by the equation:

F_{grav}=m*g (1)

where g=9.8 N/kg (on Earth) and m=mass (in kg)

In many devices, the force of gravity generates friction. The frictional force is the force exerted by a surface as an object moves across it or makes an effort to move across it. There are at least two types of friction force: kinetic and static friction. Though it is not always the case, the friction force often opposes the motion of an object. For example, if a book slides across the surface of a desk, then the desk exerts a friction force in the opposite direction of its motion. Friction results from the two surfaces being pressed together closely, causing intermolecular attractive forces between molecules of different surfaces. As such, friction depends upon the nature of the two surfaces and upon the degree to which they are pressed together. The maximum amount of frictional force that a surface can exert upon an object can be calculated using the formula below:

F_{frict}=μ·Fₙₒᵣₘ (2)

Frictional force and gravitational force often work in opposition depleting the inertia in a system in motion. The embodiments disclosed herein provide a system that can harness vector forces so that the effects of friction are overcome or at least significantly mitigated.

Newton's first law of motion is sometimes referred to as the law of inertia. The first law states that if the net force (the vector sum of all forces acting on an object) is zero, then the velocity of the object is constant. Velocity is a vector quantity which expresses both the object's speed and the direction of its motion; therefore, the statement that the object's velocity is constant is a statement that both its speed and the direction of its motion are constant.

The first law can be stated mathematically when the mass is a non-zero constant, as:

F=0 [symbol] dvdt=0

Consequently, an object that is at rest will stay at rest unless a force acts upon it and an object that is in motion will not change its velocity unless a force acts upon it.

Newton placed the first law of motion to establish frames of reference for which the other laws are applicable. The first law of motion postulates the existence of at least one frame of reference called a Newtonian or inertial reference frame, relative to which the motion of a particle not subject to forces is a straight line at a constant speed. Thus, a condition necessary for the uniform motion of a particle relative to an inertial reference frame is that the total net force acting on it is zero. In this sense, the first law can be restated as: In every material universe, the motion of a particle in a preferential reference frame Φ is determined by the action of forces whose total vanished for all times when and only when the velocity of the particle is constant in Φ. That is, a particle initially at rest or in uniform motion in the preferential frame Φ continues in that state unless compelled by forces to change it.

Newton's second law states that the rate of change of momentum of a body is directly proportional to the force applied, and this change in momentum takes place in the direction of the applied force.

The second law can also be stated in terms of an object's acceleration. Since Newton's second law is valid only for constant-mass systems, m can be taken outside the differentiation operator by the constant factor rule in differentiation. Thus, where F is the net force applied, m is the mass of the body, and a is the body's acceleration. Thus, the net force applied to a body produces a proportional acceleration. In other words, if a body is accelerating, then there is a force on it. Consistent with the first law, the time derivative of the momentum is non-zero when the momentum changes direction, even if there is no change in its magnitude; such is the case with uniform circular motion. The relationship also implies the conservation of momentum: when the net force on the body is zero, the momentum of the body is constant. Any net force is equal to the rate of change of the momentum.

The third law states that all forces between two objects exist in equal magnitude and opposite direction: if one object A exerts a force FA on a second object B, then B simultaneously exerts a force F_{B} on A, and the two forces are equal in magnitude and opposite in direction: F_{A}=−F_{B}. The third law means that all forces are interactions between different bodies, or different regions within one body, and thus that there is no such thing as a force that is not accompanied by an equal and opposite force. In some situations, the magnitude and direction of the forces are determined entirely by one of the two bodies, say Body A; the force exerted by Body A on Body B is called the “action”, and the force exerted by Body B on Body A is called the “reaction”. This law is sometimes referred to as the action-reaction law, with F_{A} called the “action” and F_{B} the “reaction”. In other situations, the magnitude and directions of the forces are determined jointly by both bodies and it isn't necessary to identify one force as the “action” and the other as the “reaction”. The action and the reaction are simultaneous, and it does not matter which is called the action and which is called reaction; both forces are part of a single interaction, and neither force exists without the other. The two forces in Newton's third law are of the same type (e.g., if the road exerts a forward frictional force on an accelerating car's tires, then it is also a frictional force that Newton's third law predicts for the tires pushing backward on the road).

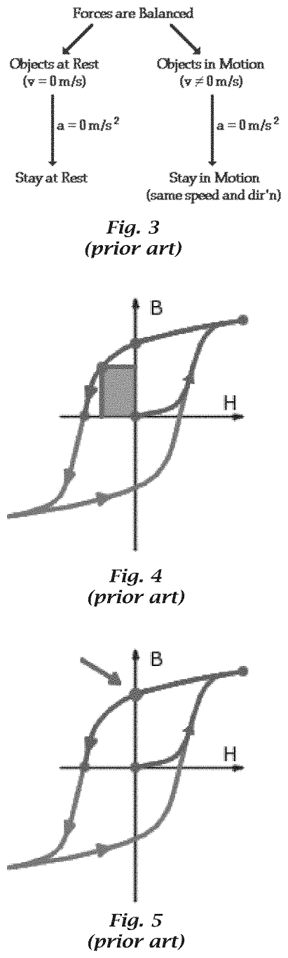

From a conceptual standpoint, Newton's third law is seen when a person walks: they push against the floor, and the floor pushes against the person. Similarly, the tires of a car push against the road while the road pushes back on the tires—the tires and road simultaneously push against each other. In swimming, a person interacts with the water, pushing the water backward, while the water simultaneously pushes the person forward—both the person and the water push against each other. The reaction forces account for the motion in these examples. These forces depend on friction; a person or car on ice, for example, may be unable to exert the action force to produce the needed reaction force (See FIG. 3).

In physics, Gauss's law for gravity, also known as Gauss's flux theorem for gravity, is a law of physics that is essentially equivalent to Newton's law of universal gravitation. Although Gauss's law for gravity is equivalent to Newton's law, there are many situations where Gauss's law for gravity offers a more convenient and simple way to do a calculation than Newton's law.

The form of Gauss's law for gravity is mathematically similar to Gauss's law for electrostatics, one of Maxwell's equations. Gauss's law for gravity has the same mathematical relation to Newton's law that Gauss's law for electricity bears to Coulomb's law. This is because both Newton's law and Coulomb's law describe inverse-square interaction in a 3-dimensional space. The gravitational field (also called gravitational acceleration) is a vector field—a vector at each point of space (and time). It is defined so that the gravitational force experienced by a particle is equal to the mass of the particle multiplied by the gravitational field at that point.

Gravitational flux is a surface integral of the gravitational field over a closed surface, analogous to how magnetic flux is a surface integral of the magnetic field.

Gauss's law for gravity states: The gravitational flux through any closed surface is proportional to the enclosed mass.

Exemplary embodiments described herein provide a method for balancing the effects of gravity by the effects of magnetism.

In physics, Gauss's law for magnetism is one of the four Maxwell's equations that underlie classical electrodynamics. It states that the magnetic field B has divergence equal to zero, in other words, that it is a solenoidal vector field. It is equivalent to the statement that magnetic monopoles do not exist. Rather than “magnetic charges”, the basic entity for magnetism is the magnetic dipole.

The law in this form states that for each volume element in space, there are exactly the same number of “magnetic field lines” entering and exiting the volume. No total “magnetic charge” can build up in any point in space. For example, the south pole of the magnet is exactly as strong as the north pole, and free-floating south poles without accompanying north poles (magnetic monopoles) are not allowed. In contrast, this is not true for other fields such as electric fields or gravitational fields, where total electric charge or mass can build up in a volume of space.

B/H Curve—The result of plotting the value of the magnetic field (H) that is applied against the resultant flux density (B) achieved. This curve describes the qualities of any magnetic material.

BHₘₐₓ (Maximum Energy Product)—the Maximum Energy Product at the point on the B/H Curve that has the most strength, expressed in MGOe (MegaGaussOersteds) (see FIG. 4).

Brₘₐₓ (Residual Induction)—also called “Residual Flux Density”. The magnetic induction remaining in a saturated magnetic material after the magnetizing field has been removed. This is the point at which the hysteresis loop crosses the B axis at zero magnetizing force, and represents the maximum flux output from the given magnet material (see FIG. 5).

(Magnetic) Dipole Moment (m)—a quantity that describes the torque a given magnet will experience in an external magnetic field. We may calculate the dipole moment using the formula m=dipole moment in A m²=Br×V/μₒ, where:

Br is Brₘₐₓ, the Residual Flux Density, expressed in Tesla.

V is the volume of the magnet, expressed in cubic meters.

μₒ is the permeability of a vacuum, or 4 π×10⁻⁷ N/A².

Ferromagnetic Material—A material that either is a source of magnetic flux or a conductor of magnetic flux. Most ferromagnetic materials have some component of iron, nickel, or cobalt. Ferrofluids are colloidal liquids made of nanoscale ferromagnetic, or ferrimagnetic, particles suspended in a carrier fluid (usually an organic solvent or water). Each tiny particle is thoroughly coated with a surfactant to inhibit clumping. Large ferromagnetic particles can be ripped out of the homogeneous colloidal mixture, forming a separate clump of magnetic dust when exposed to strong magnetic fields. The magnetic attraction of nanoparticles is weak enough that the surfactant's Van der Waals force is sufficient to prevent magnetic clumping or agglomeration. Ferrofluids usually do not retain magnetization in the absence of an externally applied field and thus are often classified as “superparamagnets” rather than ferromagnets

Gauss—Unit of magnetic induction, B. Lines of magnetic flux per square centimeter in the C.G.S. system of measurement. Equivalent to lines per square inch in the English system, and webers per square meter or tesla in the S.I. system. 10,000 gauss equals 1 tesla.

Induction, (B)—The magnetic flux per unit area of a section normal to the direction of flux. Measured in Gauss, in the C.G.S. system of units.

Magnetic Circuit—Consists of all elements, including air gaps and non-magnetic materials that the magnetic flux from a magnet travels on, starting from the north pole of the magnet to the south pole.

Magnetic Field Strength (H)—Magnetizing or demagnetizing force, is the measure of the vector magnetic quantity that determines the ability of an electric current, or a magnetic body, to induce a magnetic field at a given point; measured in Oersteds.

Magnetic Flux—Is a contrived but measurable concept that has evolved in an attempt to describe the “flow” of a magnetic field. When the magnetic induction, B, is uniformly distributed and is normal to the area, A, the flux, Φ=BA.

Magnetic Flux Density—Lines of flux per unit area, usually measured in Gauss (C.G.S.). One line of flux per square centimeter is one Maxwell.

Magnetic Line of Force—An imaginary line in a magnetic field, which, at every point, has the direction of the magnetic flux at that point.

Magnetic Pole—An area where the lines of flux are concentrated.

Magnetomotive Force (F or mmf)—The magnetic potential difference between any two points. Analogous to voltage in electrical circuits. That which tends to produce a magnetic field.

Maximum Energy Product (BHₘₐₓ)—The magnetic field strength at the point of maximum energy product of a magnetic material. The field strength of fully saturated magnetic material measured in Mega Gauss Oersteds, MGOe.

Paramagnetic Materials—Materials that are not attracted to magnetic fields (wood, plastic, aluminum, etc.). A material having a permeability slightly greater than 1.

Permeance (P)—A measure of relative ease with which flux passes through a given material or space. It is calculated by dividing magnetic flux by magnetomotive force. Permeance is the reciprocal of reluctance.

Permeance Coefficient (P_{c})—Also called the load-line, B/H or “operating slope” of a magnet, this is the line on the Demagnetization Curve where a given magnet operates. The value depends on both the shape of the magnet, and its surrounding environment (some would say, how it's used in a circuit). In practical terms, it's a number that define how hard it is for the field lines to go from the north pole to the south pole of a magnet.

Pull Force—The force required to pull a magnet free from a flat steel plate using force perpendicular to the surface. The limit of the holding power of a magnet.

By utilizing the many characteristics of magnets and magnetic fields, a precise force vector can be ascertained that can overcome the force vectors attributed to gravity. In the system described in this patent, the magnetic force vectors may be applied in direct opposition to the force vectors of gravity or in a tangential manner. An example of a tangential manner could be a loop or circle.

The embodiments described herein describe a method creating a balance and/or an alternating imbalance between gravitational fields and magnetic fields. This balanced and/or alternating imbalanced system can create movement or motion along vectors that when balanced and/or alternatingly imbalanced allows for continuous motion which overcomes the forces of friction along these same vectors. The embodiments adhere to Newton's laws:

First In an inertial frame of reference, an object either remains at rest or continues to move
law: at a constant velocity, unless acted upon by a force.
Second In an inertial frame of reference, the vector sum of the forces F on an object is equal to
law: the mass m of that object multiplied by the acceleration a of the object: F=ma. (It is assumed here that the mass m is constant—see below.)
Third When one body exerts a force on a second body, the second body simultaneously
law: exerts a force equal in magnitude and opposite in direction on the first body.

Exemplary embodiments described herein adhere to Gauss's law for magnetism which applies to the magnetic flux through a closed surface. Because magnetic field lines are continuous loops, all closed surfaces have as many magnetic field lines going in as coming out. Hence, the net magnetic flux through a closed surface is zero.

The force of friction cannot be removed, but exemplary embodiments described herein provide for negating the results of friction on a system. FIG. 1 shows an exemplary embodiment of a device for overcoming or significantly mitigating the forces of friction.

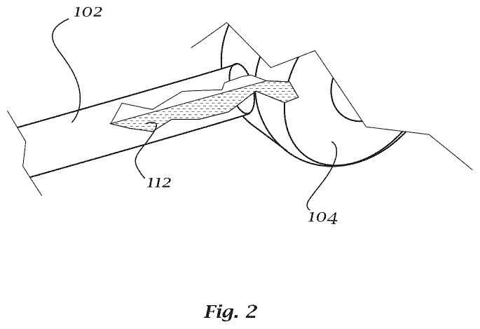

An exemplary embodiment of a device for overcoming or significantly mitigating the forces of friction may be, for example, a spoked wheel 100. The spoked wheel can include a plurality of hollow spokes 102 and a hollow hub 104. These hollow features can allow movement of substances, such as, but not limited to ferrofluids, freely from one spoke to another. The outer rim 106 does not touch the hub 104 or spokes 102. Rim 106 may be mounted on base 110 and may be coupled thereto at a lower portion of rim 106. Hub 104 may likewise be mounted on base 110 as shown in FIG. 1. The spoke and hub assembly may be half filled with a substance that is attracted to magnets, such as, but not limited to, a ferrofluid 112, as shown in FIG. 2. As a result, when two spokes 102 are in horizontal opposition to each other, due to the hub spoke assembly being half filled with ferrofluid, the two spokes would be half filled. Any rotational motion along the center axis would allow gravitational forces to cause the ferrofluid to flow in the direction of the rotation. In other words, the ferrofluid would begin to flow downwards towards the lowered spoke. As gravitation forces pull on the additional weight of the ferrofluid, the hub and spoke assembly can continue to rotate along the axis, creating momentum or inertia. The force of friction being exerted on the hub and spoke assembly would eventually cause this motion to stop unless additional force is applied to the hub spoke assembly. In some exemplary embodiments, such force may be supplied by the addition of a magnet such as a Neodymium grade N52 magnet 108, or the like, located on the outer rim, for example at point A. The magnet 108 can create a magnetic field measured in units referred to as Gauss. The magnetic field strength is the measure of the vector magnetic quality that determines the ability of a magnetic body to induce a magnetic field. This magnetic field strength is measured in Oersteds. In this example, the magnetic field strength exerted from the magnet at point A can provide sufficient force to overcome the force of friction and lift spoke 102a from point B to a point that it is above horizontal.

As this occurs, the gravitational vector forces acting on the ferrofluid can cause the ferrofluid to shift towards the vector gravitational force acting on spoke 102b, opposite the spoke 102a being attracted towards the magnetic field. The momentum created by the shifting of the ferrofluid from point B towards point C would generate a rotational vector force on the hub and wheel assembly. The resultant inertia acting on the hub and wheel assembly would cause spoke 102c to rise towards magnet 108 located at point A. The magnetic field strength of magnet 108 at point A would be such that the magnetic flux density attracts the ferrofluid towards the magnet 108. As spoke 102c reaches a point past horizontal, the ferrofluid, acted upon by gravitational vector forces, moves away from magnet 108. This movement generates inertia in the hub and wheel assembly. This resultant rotational force vector elevates spoke 102d towards the magnet 108 located at point A.

The process of this method can continue to rotate the hub and spoke assembly. Ferrofluid has been used in this example as a material attracted to a magnet. However, it should be appreciated that other materials that are attracted to a magnet can be used in other exemplary embodiments or materials that are not attracted to a magnet can be used. Materials or combinations of materials that are attracted to magnets and that move easily may be utilized, such as, but not limited to ferrous fluid, mercury, ball bearings, fillings, etc. A magnetically sensitive gas or plasma may also be used in some embodiments. Some exemplary embodiments may utilize a magnet at point A, a magnet at another location on rim 106, or multiple magnets at various locations on rim 106.

In some exemplary embodiments, the device for overcoming or significantly mitigating the forces of friction may be circular structure or a spherical structure, or any other shape that allows the device to function as described herein.

In some exemplary embodiments, the device for overcoming or significantly mitigating the forces of friction may be a vertical device or horizontal device.

In some exemplary embodiments, the device for overcoming or significantly mitigating the forces of friction may use force vectors in any orientation deemed appropriate to overcome frictional forces.

In some exemplary embodiments, the device for overcoming or significantly mitigating the forces of friction may use gravity as a force or may not use gravity as a force.

Newton's second law pertains to the behavior of objects for which all existing forces are not balanced. The exemplary embodiments described herein can take advantage of forces that are not balanced. By utilizing forces that are not balanced but that exert force vectors in alternating opposition, exemplary embodiments of the device can maintain momentum in objects. This resulting momentum and inertia can be utilized in devices to accomplish work. The methods described in exemplary embodiments may be used in the generation of power, in the movement of objects at rest, in the alteration in movement of objects already in motion, and in any other desired function or in a device.

Thus, according to the above exemplary embodiments and descriptions, a method of utilizing force vectors to influence movement in an object and these force vectors may utilize gravitation forces and magnetic forces. The force may be gravitational, magnetic, or frictional. Forces may be oriented so that they may be applied to an object singularly or in combination or combinations with other forces. The forces may work alternately in exerting their effects, or the forces may work continually to exert effects.

Additionally, the temperature can be adjusted so that the force vectors may be influenced.

Further, magnetic forces may be exerted by permanent magnets or electromagnets. Further, the ferrofluid can be used to receive the force exerted by the magnet or magnets or, alternatively, mercury can be used to receive the force exerted by the magnet or magnets. In another embodiment, ball bearings could be used to receive the force exerted by the magnet or magnets.

Additionally, in an exemplary embodiment, particles attracted to a magnetic field are used. Alternatively, in exemplary embodiments, methods may utilize a material or materials either affected or not affected by magnetic fields. Further, exemplary embodiments can utilize force vectors in a linear direction, in a tangential direction or in a combination of directions that result in varied movements. Additionally, magnetic force can be applied by one or by multiple magnets. Also, magnetic force may be applied in various locations in the system.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art (for example, features associated with certain configurations of the invention may instead be associated with any other configurations of the invention, as desired).

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. An apparatus for mitigating the forces of friction, comprising:
a magnetically sensitive substance;
at least one first vessel for containing the magnetically sensitive substance such that the magnetically sensitive substance moves freely within the vessel between a first end of the vessel and a second end of the vessel;
at least one second vessel for containing the magnetically sensitive substance such that the magnetically sensitive substance moves freely within the vessel between a first end of the vessel and a second end of the vessel, the first vessel and second vessel being coupled to each other such that movement of the first vessel results in movement of the second vessel; and
at least one magnet disposed such that the first vessel and second vessel come into proximity with the magnet in repeated alternating succession;
wherein, when a vessel is in proximity with the magnet, the magnet exerts a force on the magnetically sensitive substance within the vessel, creating movement of the vessel; and
wherein, as the vessel moves, the orientation of the vessel changes, such that the magnetically sensitive substance moves from the first end of the vessel towards the second end of the vessel due to the force of gravity.

2. The apparatus of claim 1, wherein the magnetically sensitive substance is a liquid.

3. The apparatus of claim 2, wherein the liquid is a ferrofluid.

4. The apparatus of claim 1, wherein the magnetically sensitive substance is a solid.

5. The apparatus of claim 1, wherein the magnetically sensitive substance is a gas or plasma.

6. The apparatus of claim 1, further comprising a plurality of magnets.

7. The apparatus of claim 1, wherein the movement of the vessel is rotational.

8. The apparatus of claim 1, wherein the movement of the vessel is linear.

9. An apparatus for mitigating the forces of friction, comprising:
a hollow hub having a void therein and rotationally mounted on a support;
a plurality of hollow spokes coupled to and extending from the hub, each spoke of the plurality of spokes having a void therein, the voids of the plurality of spokes being in communication with the void of the hub, each spoke having a proximal end coupled to the hub and a distal end;
a magnetically sensitive substance disposed within the void of the spokes and the void of the hub;
a magnet disposed in sufficient proximity and strength to exert a force on the magnetically sensitive substance within a spoke of the plurality of spokes when the distal end of the spoke is proximate the magnet;
wherein, as the hub rotates and as a spoke moves past a horizontal position, the magnetically sensitive substance moves within the void of the spoke under the effect of gravity.

10. The apparatus of claim 9, further comprising a circular rim surrounding the plurality of spokes such that the distal end of each spoke is disposed proximate the rim without contacting the rim, wherein the magnet is disposed on the rim.

11. The apparatus of claim 10, further comprising a plurality of magnets disposed on the rim.

12. The apparatus of claim 9, wherein the magnetically sensitive substance is a liquid.

13. The apparatus of claim 12, wherein the liquid is a ferrofluid.

14. The apparatus of claim 9, wherein the magnetically sensitive substance is a solid.

15. The apparatus of claim 9, further comprising a plurality of magnets.
